(19) United States
(12) Patent Application Publication
(10) Pub. No.: US 2014/0175790 A1
(43) Pub. Date: Jun. 26, 2014

(54) FILLER-NECK COUPLING

(71) Applicants: Wilfried-Henning Reese, Unterscheleissheim (DE); Martin Brücklmeier, Icking (DE); Roland Szardenings, Wolfratshausen (DE)

(72) Inventors: Wilfried-Henning Reese, Unterscheleissheim (DE); Martin Brücklmeier, Icking (DE); Roland Szardenings, Wolfratshausen (DE)

(21) Appl. No.: 13/825,401

(22) PCT Filed: Oct. 8, 2011
(86) PCT No.: PCT/EP11/05041

§ 371 Date: Mar. 13, 2014

(30) Foreign Application Priority Data
Oct. 13, 2010 (DE) 10 2010 048 383.4

(51) Int. Cl. F16L 59/18; F17C 13/00

(52) U.S. Cl. CPC F16L 59/182; F17C 13/001
USPC 285/54; 285/355

(57) ABSTRACT

Described as a filler-tank coupling, exhibiting

a) a coupling plug (S),
b) in which is arranged an axially movable conduit (R),
c) a coupling socket (D) corresponding to the coupling plug (S),
d) wherein the conduit (R) extends beyond the parting plane (T) into the coupling socket (D) in the coupled state, so that a media opening (9) provided in the front area of the conduit (R) becomes aligned with the inlet opening of a media line (L) arranged in the coupling socket (D), and
e) means for joining the coupling plug (S) and coupling socket (D).
According to the invention
f) the conduit (R) has an insulated design (1),
g) a first insulating body (2) is arranged at the front end of the conduit (R),
h) the coupling socket (D) exhibits a second insulating body (6) that can move in an axial direction and corresponds to the first insulating body (2), and
i) the conduit (R), first insulating body (2) and second insulating body (6) are sealed gastight (3, 4, 7).

The invention relates to a filler-neck coupling, exhibiting

a) a coupling plug,

b) in which is arranged an axially movable conduit,

c) a coupling socket corresponding to the coupling plug,

d) wherein the conduit extends beyond the parting plane into the coupling socket in the coupled state, so that a media opening provided in the front area of the conduit becomes aligned with the inlet opening of a media line arranged in the coupling socket, and

e) means for joining the coupling plug and coupling socket.

The invention further relates to the use of a filler-neck coupling for filling storage devices suitable for cryopressure storage.

The following designation “LH₂” stands for liquid hydrogen, while “GH₂” denotes gaseous hydrogen.

Various hydrogen storage methods are known from prior art. These are: high-pressure storage of GH₂, wherein accumulator pressures of up to 700 bar are currently being realized, storage of LH₂ as well as storage of metal hydrides. Another alternative type of storage referred to as “cryopressure storage” enables comparatively high accumulator densities given a comparatively low weight for the accumulator device required for this purpose. As a consequence, cyropressure storage combines the advantages of liquid storage with the advantages of pressure storage.

Cryopressure storage is characterized by the fact that supercooled hydrogen preferably having a temperature of between 30 and 80 K is stored in a suitable container at a pressure of several hundred bar, preferably at a pressure of 250 50 to 350 bar [?]. While fill-up methods along with corresponding filler-neck couplings already exist for the high-pressure storage, liquid storage and metal hydride storage types of storage mentioned at the outset, this is not the case in cryopressure storage.

The containers that had previously existed only at test facilities are joined with a filling unit by means of fixed conduits and/or hoses. These containers can only be filled after comprehensive inertizing and pressure-changing rinses as well as tightness tests.

The object of the present invention is to indicate a generic filler-neck coupling that enables the filling of containers suitable for cryopressure storage. Therefore, the objective of the invention is to provide as simple and cost-effective method as possible for filling cryopressure containers by means of a special cryopressure coupling, wherein the latter is to permit as comparatively uncomplicated an operation in terms of handling and filling process as for the known filler-neck couplings for GH₂ and LH₂.

Proposed for achieving this object is a filler-neck coupling characterized by the fact that

f) the conduit has an insulated design,

g) a first insulating body is arranged at the front end of the conduit,

h) the coupling socket exhibits a second insulating body that can move in an axial direction and corresponds to the first insulating body, and

i) the conduit, first insulating body and second insulating body are sealed gastight.

Additional advantageous embodiments of the filler-neck coupling according to the invention represent subjects of the dependent claims, and are characterized by the fact that
the second insulating body is spring-loaded in design,
means for determining the position of the conduit are provided,
the means for joining the coupling plug and coupling socket are designed as a detachable screwed connection and/or a bracing, wherein the bracing preferably is designed as a ball-in-groove bracing or mold-in-groove bracing, and
means for heating and/or cooling are allocated to the coupling plug and/or coupling socket.

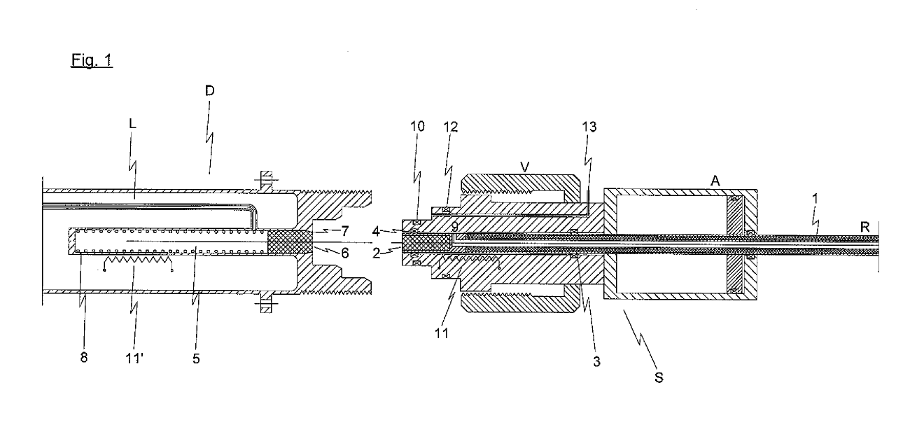

The filler-neck coupling according to the invention as well as additional advantageous embodiments of the latter will be explained in greater detail below based on the exemplary embodiments depicted on FIGS. 1 to 3, which present lateral sectional views of a possible embodiment of the filler-neck coupling. The figures here show:

FIG. 1: A filler-neck coupling in the decoupled state

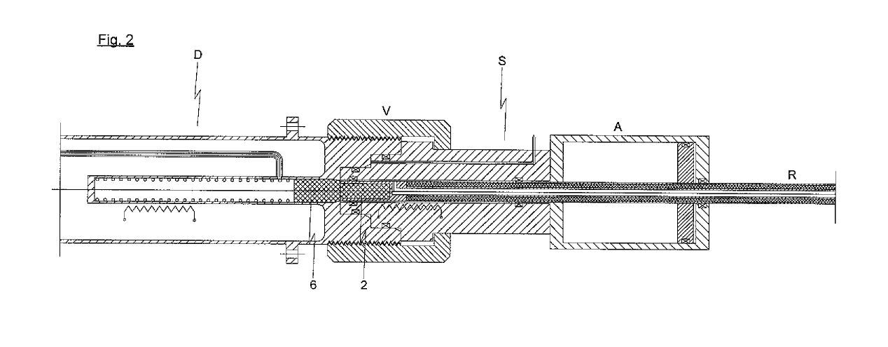

FIG. 2: A filler-neck coupling in the joined state, wherein the conduit is not yet displaced beyond the parting plane and into the coupling socket

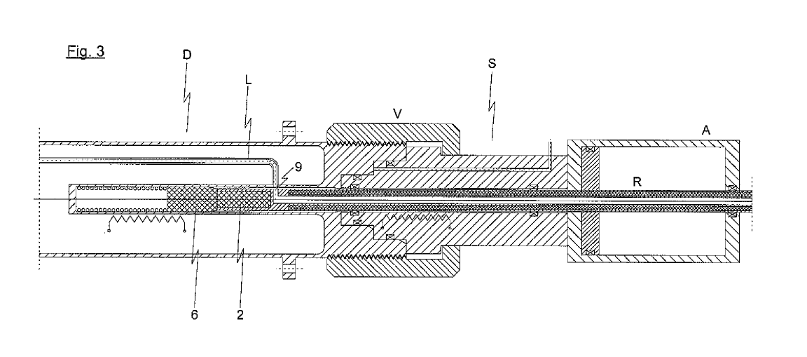

FIG. 3: A filler-neck coupling in the joined state, wherein the conduit is displaced beyond the parting plane and into the coupling socket

Note: For the sake of clarity, most of the reference symbols and numbers indicated on FIG. 1 are not given again on FIGS. 2 and 3.

For the sake of clarity, the figures do not depict the media lines used to supply the medium to the filler-neck coupling and remove it from the latter. The filler-neck coupling exhibits a coupling plug S and coupling socket D. The coupling plug S incorporates a conduit R that can move in an axial direction. The conduit R is displaced by means of a drive A. While the latter can be designed as a pneumatic or hydraulic piston drive, an electric drive is also possible, e.g., via a spindle. In the coupled state (see FIG. 3), the conduit R extends beyond the parting plane T into the coupling socket D or into a cylinder chamber 5 provided therein, so that a media opening 9 provided in the front region of the conduit R becomes aligned with the inlet opening of a media line L arranged in the coupling socket D. In this position, the medium to be overfilled can flow through the filler-neck coupling.

According to the invention, the conduit R now has an insulated design, to which end the actual media line is enveloped by a vacuum insulation 1, for example. Such insulation can be used to thermally insulate the medium flowing through the conduit R against the warm sections of the coupling plug S in a radial direction. The term “warm” below refers to temperatures of −40 to +85° C., while the term “low temperatures” stands for temperatures below −40° C., and the term “cryogenic temperatures” stands for temperatures of between −270 and −150° C.

According to the invention, a first insulating body 2 is arranged at the front end of the conduit R, while the coupling socket D exhibits a second insulating body 6 that corresponds to the first insulating body 2 and can move in an axial direction. It is arranged in the mentioned cylinder chamber 5, and preferably has a spring-loaded design. As a consequence, it performs the function of a spring-loaded check valve. This insulating body is used to ensure a thermal insulation toward the parting plane T in the decoupled state. In addition, the conduit R, first insulating body 2 and second insulating body 6 are sealed gastight. This is achieved with seals 3, 4 and 7. According to the invention, the cryogenic sections or parts of the coupling system are designed in such a way that they can guide the (cryogenic) medium insulated from the outer, warm sections, without the medium becoming directly sealed at cold temperatures.

In principle, any mechanism that withstands the maximum arising or required pressure can be used to join or brace the coupling plug S and coupling socket D, as denoted by a screwed connection V on the figures. A quick bracing with ball-in-groove bracing or mold-in-groove bracing is possible as an alternative to a mechanical screwed connection. The coupling plug S and coupling socket D are advantageously flanged with each other by means of a quick bracing system of the kind already in use for LH₂ and GH₂ filler-neck couplings. The area of the coupling plug S facing the coupling socket D exhibits at least one sealing element 10 that forms a seal relative to the environment, and enables a gastight bracing seal. Such a seal-producing sealing element can additionally or alternatively also be situated in the coupling socket D.

The fueling or filling process that can be realized with the filler-neck coupling according to the invention will be explained below in detail. As depicted on FIG. 2, after the coupling plug S and coupling socket D have been connected, the flanging V is sealed gastight by means of the sealing element 10.

The geometry for such areas of the coupling plug S and coupling socket, which bump against each other while being joined, is designed in such a way as to avoid dead spaces and air pockets toward the media chamber. This eliminates the usual need to rinse any dead space that might be present, which would be required to remove carrier gases, moisture and oxygen (explosion hazard!).

The first insulating body 2 arranged at the front end of the conduit R now abuts against the second insulating body 6 that corresponds thereto and can move in an axial direction. Since the cryogenic medium has no direct contact with the insulating bodies 2 and 6, the insulating bodies are effectively prevented from being cooled by the cryogenic medium. If the conduit R is now displaced beyond the parting plane T into the coupling socket D as shown on FIG. 3, a media opening 9 provided in the front area of the conduit R becomes aligned with the inlet opening L arranged in the coupling socket D in its end position, allowing medium to flow out of the coupling plug S and into the coupling socket D.

The filler-neck coupling according to the invention preferably exhibits means for determining the position of the conduit R. At least one corresponding sensor is used to ascertain the proper position of the conduit R, and only thereafter is filling with the (cryogenic) medium initiated.

After the filling process is complete, the conduit R, and hence the first insulating body 2, are again retracted into the coupling plug S. The warm seal 10 ensures that the coupling plug S is sealed relative to the environment for the entire filling process. The seal between the coupling socket side D and the coupling socket-side second insulating body or check valve 6 is also established by means of a warm seal 7. The latter is arranged in such a way as not to be exposed to a flow and cooling in the filling process.

Due to its construction, the filler-neck coupling according to the invention makes it possible to separate the coupling plug S and coupling socket D immediately after the filling process is complete without a time-consuming heating step, and to achieve a durable seal for the opened flange sides relative to the environment. This eliminates the need for lengthy rinsing processes and heating times before, during and/or after connection of the coupling plug and coupling socket.

Despite the insulating measures described above, it is technically unfeasible to completely prevent exposure of the medium to a heat flow. This heat flow would cause the components enveloping the cryogenic areas of the coupling to cool given longer fill times and depending on the insulation quality. In order to prevent this, means for heating and/or cooling are preferably allocated to the coupling plug S and/or coupling socket. For example, the coupling plug S and/or coupling socket D can be provided with (a) heating device(s) 11/11′, which prevent(s) the warm components from being cooled by supplying warmth. The corresponding components of the coupling socket D are also kept at an ambient temperature through mechanical connection with the coupling socket D and the use of readily conductive materials of the flange connection. In order to prevent the second insulating body or check valve 6 from undesirably cooling in the filling process in the area of the coupling socket D not exposed to a flow, a heating element or structural configuration of a thermally conductive connection can be used to supply warmth to this area.

After the coupling plug S and coupling socket D have been joined and/or during the filling process, the tightness of the flange connection can be monitored via a second seal 12 provided on the coupling plug S, which comprises a testing chamber. Alternatively or additionally, this type of seal can also be arranged in the coupling socket. For purposes of the tightness check, a suitable test gas is supplied to the testing chamber via line 13.

The filler-neck coupling according to the invention achieves the set object, specifically of handling high pressures and cryogenic temperatures within a coupling system. The additional structural outlay required to this end by comparison to known LH₂ and GH₂ filler-neck couplings would appear acceptable in light of the attainable advantages. This makes the filler-neck coupling according to the invention especially suitable as a filler-neck coupling for filling storage devices, which are suitable for cryopressure storage. However, the filler-neck coupling according to the invention can essentially also be used for filling LH₂ and GH₂ storage devices.

1. A filler-neck coupling, comprising
a) a coupling plug,
b) in which is arranged an axially movable conduit,
c) a corresponding to the coupling plug,
d) wherein the conduit extends beyond the parting plane into the coupling socket in the coupled state, so that a media opening provided in the front area of the conduit becomes aligned with the inlet opening of a media line arranged in the coupling socket, and
e) Means for connecting to the coupling plug and the coupling socket,
characterized in that
f) the conduit has an insulated design,
g) a first insulating body is arranged at the front end of the conduit,
h) the coupling socket exhibits a second insulating body that can move in an axial direction and corresponds to the first insulating body, and
i) the conduit, first insulating body and second insulating body are sealed gastight.

2. The filler-neck coupling according to claim 1, characterized in that the second insulating body is spring-loaded in design.

3. The filler-neck coupling according to claim 1, characterized in that means for determining the position of the conduit are provided.

4. The filler-neck coupling according to claim 1, characterized in that the means for joining the coupling plug and coupling socket are designed as a detachable screwed connection and/or a bracing.

5. The filler-neck coupling according to claim 4, characterized in that the bracing is designed as a ball-in-groove bracing or mold-in-groove bracing.

6. The filler-neck coupling according to claim 1, characterized in that means for heating and/or cooling are allocated to the coupling plug and/or coupling socket.

7. (canceled)

8. The filler-neck coupling according to claim 1, characterized in that the filler-neck coupling is present in a storage device.

9. The filler-neck coupling according to claim 8, characterized in that the filler-neck coupling assists in filling the storage device.

10. The filler-neck coupling according to claim 8, characterized in that the storage device is a cryopressure storage device.
